(19) United States
(12) Patent Application Publication
(10) Pub. No.: US 2022/0263676 A1
(43) Pub. Date: Aug. 18, 2022

(54) ONLINE MEETUP SYNCHRONIZATION

(71) Applicants: Anantha K. Pradeep, Piedmont, CA (US); Devin Pracar, Piedmont, CA (US); Liam Cisneros Morley, Eugene, OR (US); Cameron Johnson Bolt, Lantana, FL (US); Aryan Nair, Apex, NC (US); Jennifer Johnson, Lantana, FL (US)

(72) Inventors: Anantha K. Pradeep, Piedmont, CA (US); Devin Pracar, Piedmont, CA (US); Liam Cisneros Morley, Eugene, OR (US); Cameron Johnson Bolt, Lantana, FL (US); Aryan Nair, Apex, NC (US); Jennifer Johnson, Lantana, FL (US)

(21) Appl. No.: 17/179,206

(22) Filed: Feb. 18, 2021

(51) Int. Cl. H04L 12/18; G06Q 10/10

(52) U.S. Cl. CPC H04L 12/1818; G06Q 10/1093

(57) ABSTRACT

Mechanisms are provided to determine interest information for a plurality of employees in a workplace environment. The interest information is determined by analyzing employee work product, employee communications, and personality profiles. The interest information is analyzed to place the employees into connection groups including game groups and chat groups. Games groups and chat groups are calendared and scheduled upon reviewing the work availability calendars of employees. Participation rates are tracked to determine connection levels to enhance connection groups. The participation rates may be further tracked to automatically adjust employee reviews.

### BACKGROUND

Technology has allowed increasing numbers of employees to work outside of a centralized office. Employees may work from home, in satellite offices, or in distant locations as long as they have at least periodic Internet connectivity. These remote employees can access the same databases, participate in real-time text chats, collaborate over video or audio conferences, and jointly work on the same files.

However, technology has not been as effective at encouraging casual interactions. Casual interactions are often important for building trust, sharing ideas, improving work relationships, sparking creativity, and venting frustrations. Employees who generally do not have meetings together could discuss inter-departmental problems and solutions. Others could find shared interests or common ground. Employees usually reluctant to share ideas at formal meetings could brainstorm solutions in a more casual setting. Casual communications and familiarity can create a more positive work environment.

Consequently, it is desirable to improve existing technologies to further enhance workplace cohesion and morale.

### OVERVIEW

Mechanisms are provided to enhance workplace casual connectivity in a remote environment. Existing data gathering mechanisms are leveraged to obtain interest information for particular employees. In some examples, this information is obtained explicitly through questionnaires and employee input. In other examples, the information is obtained implicitly through workplace activity participation databases, employee communications, personality profiles and reviews, personality assessments, and other techniques available specifically in workplace environments. Interest information is analyzed to match employees into game groups and chat groups and employees are automatically invited to participate in these game groups and chat groups that may occur during break or working hours. Participation in these game groups and chat groups is evaluated to determine satisfaction and connection levels so that groupings can further be enhanced.

### BRIEF DESCRIPTION OF THE DRAWINGS

FIG. 1 illustrates one example of a system that can be used to enhance online meetup synchronization.

FIG. 2 illustrates one example of a technique for providing employees with access to connection groups.

FIG. 3 illustrates one example of a technique for obtaining employee data.

FIG. 4 illustrates one example of a technique for monitoring success rates of employee meetups through explicit and implicit mechanisms.

FIG. 5 illustrates one example of a technique for facilitating a connection group.

FIG. 6 illustrates one example of a computer system.

### DETAILED DESCRIPTION OF EXAMPLE EMBODIMENTS

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

### INTRODUCTION

As increasing numbers of employees work from home, in satellite offices, or in distant locations with the assistance of Internet connectivity, casual interactions between co-workers and employees that was once common in physical workplaces has been difficult to emulate in remote working arrangements. Because casual interactions are often important for building trust, sharing ideas, improving work relationships, sparking creativity, and venting frustrations, finding a way to encourage casual interactions in a remote working environment is desirable for creating a more positive work environment.

Accordingly, various examples of systems and processes are described herein that provide enhanced online meetups for employees. These meetups can include chat groups, game groups, or other groups that improve workplace cohesion and morale. With the implementation of these meetups, employees can develop deeper casual relationships that can improve their remote working experiences.

### System Examples

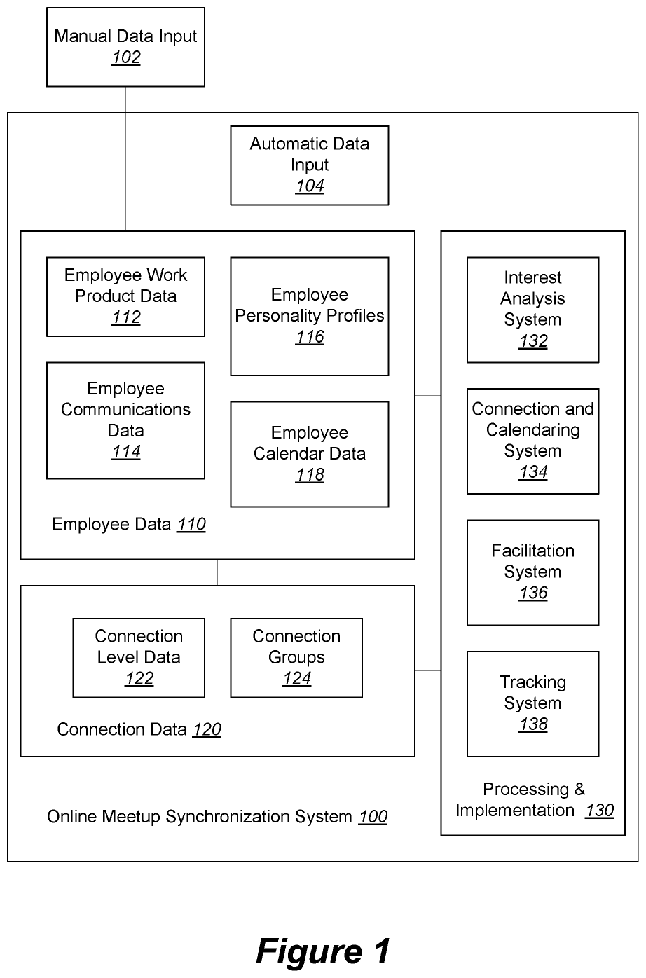

With reference to FIG. 1, shown is one example of a system that can be used to implement online meetups for employees. In this example, online meetup synchronization system 100 includes employee data 110, connection data 120, and processing and implementation 130. The employee data 100 is used by processing and implementation 130 to select connection groups 124 that match employees' interests.

According to various embodiments, the employee data 110 is analyzed by interest analysis system 132 to determine employee interests. In some implementations, the employee data 110 is obtained explicitly through manual data input 102, such as through questionnaires and employee input. In other implementations, the employee data 110 is obtained implicitly through automatic data input 104, such as through workplace activity participation databases, employee communications, personality profiles and reviews, personality assessments, and other techniques available specifically in workplace environments.

In the present example, employee data 110 includes employee work product data 112, employee communications data 114, employee personality profiles 116, and employee calendar data 118. The employee work product data 112 can include information such as projects, departments, positions, and other work related interests associated with each employee. The employee communications data 114 can include information such as which employees interact with each other, how frequently they interact, and ways that the employees interact (e.g. email, phone, chat/messaging, videocall, etc.). The employee personality profiles 116 can include information such as self-assessments, reviews by others, personality test results, self-provided biographies, and the like. The employee calendar data 118 includes information about employee schedule availability. In some examples, this can include both work-related and personal entries on employee calendars to facilitate scheduling based on employee availability. In other examples, this may include only work-related entries, such as when there are designated work hours and any un-scheduled work time would be considered available for scheduling connection group events.

In the present example, the connection and calendaring system 134 matches the employees with connection groups 124 based on the employee interests determined by the interest analysis system 132. Specifically, interest analysis system 132 determines from the employee data 110 which interests are associated with each employee. These interests can be selected from various categories of interests available. Available activities, such as games, chat groups, etc. can also be assigned to interest categories. In the present example, the connection and calendaring system 134 uses the interests determined for each employee to assign the employee to one or more activities and/or events that match the employee's interests. The connection and calendaring system 134 then determines employee availability from employee calendar data 118 and adds the activities and/or events to the employee's calendar. Accordingly, an employee with several interests may be scheduled for several events and/or activities. In some examples, the events and/or activities can be scheduled as optional and shown as “busy” if the employee confirms that they intend to participate in the event and/or activity. In this way, employees can determine which events and/or activities are upcoming and whether they'd like to attend. Additionally, in some examples, participation may be casual so that employees can decide whether to drop-in during a break, similar to visiting a break room at a physical workplace, without having to confirm attendance ahead of time.

According to various examples, facilitation system 136 encourages employee engagement with the connection groups by providing guidance for participants. For instance, this guidance can include providing prompts and information to participants of a connection group event. Specifically, facilitating a connection group may include features such as greeting or welcoming employees to the activity, providing instructions, rules, and/or goals to the employees regarding the activity, providing prompts as necessary to encourage participation by employees in the activity, and providing closing remarks or leading a discussion before the activity ends. Other interactive features can also be included, depending on the implementation. For instance, the facilitation system 136 may include help features or reporting features if desired. Although the facilitation system 136 can be automated to function without a specific person leading an activity, the facilitation system 136 can also incorporate human facilitators as well if desired. For instance, a chat feature can be included that allows a human facilitator to answer questions as necessary. According to various embodiments, the facilitation system 136 provides an organized and consistent experience for employees participating in the connection groups.

In the present example, a tracking system 138 assesses employee participation rates and satisfaction rates to improve placement of employees in connection groups, provide employee reviews, and adjust compensation as appropriate. In some implementations, participation in these game groups and chat groups is evaluated to determine satisfaction and connection levels so that groupings can further be enhanced. For instance, the tracking system 138 can compare the recommended events for a particular employee to the events that the employee actually attended to determine what types of activities to recommend in the future. In some examples, the tracking system 138 may also detect factors such as time of day or day of the week when an employee tends to participate in activities to refine the recommendations for future events. Depending on the implementation, scheduling of future events can be shifted based on demand and past attendance of employees. In some applications, satisfaction rates can also be assessed based on factors such as employee interaction during activities and feedback provided by employees after an activity. Furthermore, satisfaction rates can be used to determine connection levels. The connection levels can reflect the connections with certain interests and employees.

According to various embodiments, employee participation rates may be used to provide employee reviews and/or adjust compensation. For instance, employee reviews may include information about how invested an employee seems in their workplace based on how often they participate in connection group activities. In addition, in some reviews, peers or supervisors may include social evaluations as part of the employee reviews to reflect how well the employee gets along with others and engages with the company. In some implementations, compensation may be adjusted based on employee participation, such as by providing bonuses for employees that reach a certain level of participation or feedback from peers and/or supervisors.

In the present example, the connection data 120 includes connection level data 122 and connection groups 124. The connection level data 122 may include information such as the degree of engagement an employee has with particular interests and activities, as well as the degree of interaction with other employees. The connection groups 124 can include information about what activities and interests are available to employees participating in the system 100.

Although the present example shows one configuration of an online meetup synchronization system 100, it should be recognized that other configurations can also be implemented within the scope of this disclosure. For instance, additional data sources can be included in employee data 100 depending on the implementation. Furthermore, additional features such as feedback and suggestion systems or data can also be added if desired.

### Operating Examples

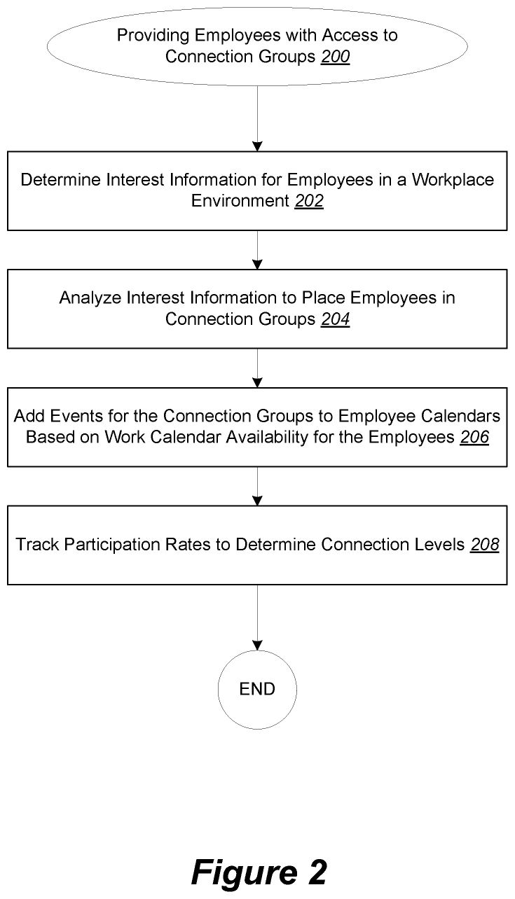

As described above with regard to FIG. 1, a system can be implemented to provide employees with access to connection groups that can improve workplace cohesion and morale and allow employees to improve their remote working experiences through casual interactions and gatherings with co-workers. The system can be implemented in various ways, one of which is described in conjunction with FIG. 2. Of course the system 100 can also be used with other processes depending on the application.

With reference to FIG. 2, shown is one example of a technique for providing employees with access to connection groups. In the present example, the process 200 begins with determining interest information for employees in a workplace environment. As described above with regard to FIG. 1, interest information can be determined by analyzing employee data such as employee work product data, employee communications data, and personality profiles, depending on the implementation. Existing data gathering mechanisms are leveraged to obtain interest information for particular employees. This employee data can be obtained through manual input and/or automatic input. For instance, manual input may include employees filling out questionnaires, completing assessments, and/or selecting interests/activities explicitly. Additionally, automatic input may include data obtained by the system about aspects such as what types of work the employee does, who the employee communicates with, etc. as deduced from the employee's work activities. In some examples, the information is obtained automatically through workplace activity participation databases, employee communications, personality profiles and reviews, personality assessments, and other techniques available specifically in workplace environments. Depending on the desired implementation, the employee data may include a subset of the data described or additional types of data that may be helpful to determine employee interests.

In the present example, the process 200 continues at 204 with analyzing the interest information to place the employees into connection groups. The connection groups may include any group that offers an activity that multiple employees can engage in and interact with. For instance, connection groups can include game groups, chat groups, and the like.

Next, in the present example, events for the connection groups are added to employee calendars based on employee interests and employee work calendar availability at 206. For instance, chat groups and/or game groups are automatically scheduled on employee calendars. Specifically, game groups, chat groups, and/or any other groups are scheduled upon reviewing the work availability of the employees and the interests of the employees. For instance, after interest information is analyzed to match employees into game groups and chat groups, the employees are automatically invited to participate in these game groups and chat groups that may occur during break or working hours. In some examples, the connection groups can be scheduled after determining when most employees with a particular interest are available. In other examples, the connection groups can be pre-scheduled and employees who happen to be available during these times can be added to the events.

In the present example, the process 200 continues at 208 by tracking participation rates. Specifically, participation rates are determined through mechanisms such as time connected to a video conference, engagement with a game, and/or other connection group activity. In some implementations, participation rates are used to determine connection levels to enhance the connection groups. Specifically, participation in game groups and chat groups is evaluated to determine satisfaction and connection levels so that groupings can further be enhanced. The participation rates can be used to determine aspects such as which connection groups are well attended and should continue and which ones should be removed. Additionally, participation rates can be used to automatically adjust employee reviews in some applications, such as when participation rates are counted towards employee performance, etc. Furthermore, participation rates can also be used to adjust employee compensation in some instances.

In some examples, satisfaction rates can be determined based on implicit user interactions with the game groups, chat groups, or other connection groups. The satisfaction rates can then be used to determine connection levels. According to various embodiments, the participation rates, satisfaction rates, and/or connection levels can be used to refine which activities or connection groups should be assigned to or recommended to employees based on their past participation.

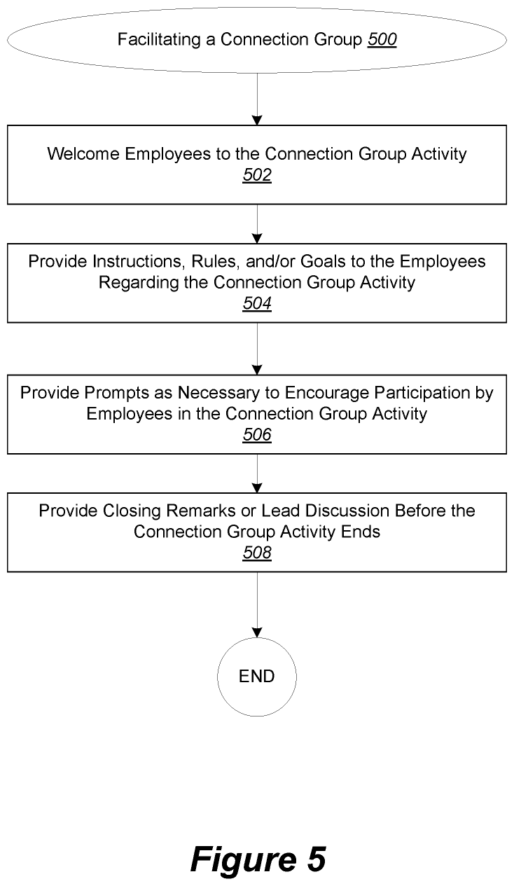

Although particular processes have been described in conjunction with FIG. 2, additional processes can also be implemented within the scope of this disclosure. For instance, as described in more detail below with regard to FIG. 5, the process can also include facilitating the connection groups virtually to provide an organized and consistent experience for employees participating in the connection groups. Specifically, the connection groups can be automatically facilitated to allow employees to easily engage with connection group activities without the need for a human moderator or leader.

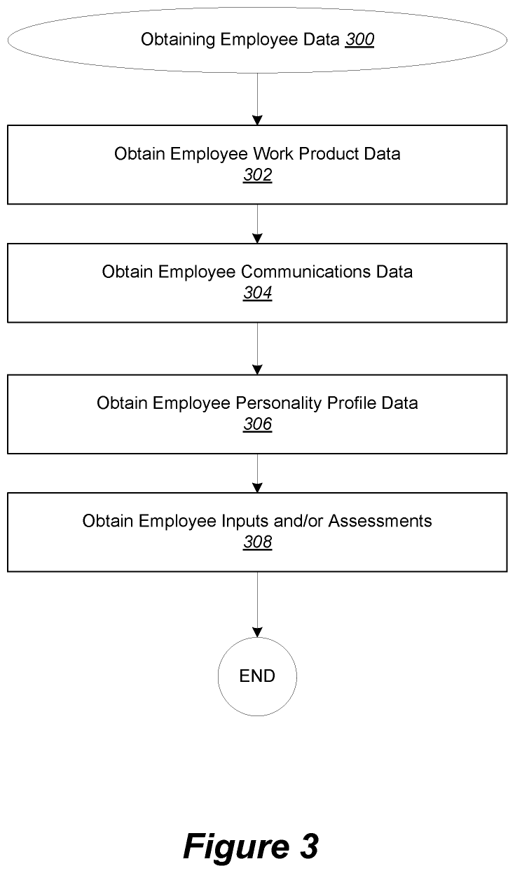

As described above, a key aspect to providing employees with access to connection groups is the employee data that is used to determine employee interests. Depending on the types of information available and relevant to a particular workplace, different sets of employee data may be available. Accordingly, the employee data can be chosen to suit the particular implementation in a workplace. One example of a process for obtaining employee data is shown in FIG. 3.

With reference to FIG. 3, the process 300 begins with obtaining employee work product data at 302. As described previously, employee work product data 112 can include information such as projects, departments, positions, and other work related interests associated with each employee. This employee work product data can be obtained through manual input and/or automatic input, depending on the desired implementation. For instance, manual input may include employees filling out questionnaires or completing assessments about their work activities explicitly. In contrast, automatic input may include data obtained by the system about aspects such as what types of work the employee does, as deduced implicitly from the employee's work activities.

In the present example, the process continues at 304 with obtaining employee communications data. The employee communications data 114 can include information such as which employees interact with each other, how frequently they interact, and ways that the employees interact (e.g. email, phone, chat/messaging, videocall, etc.). This employee communications data can be obtained through manual input and/or automatic input, depending on the implementation. For instance, manual input may include employees filling out questionnaires and/or listing their contacts and co-workers explicitly. In contrast, automatic input may include data obtained by the system about who the employee communicates with, etc. as deduced from the employee's email activities, contact list, etc. In some examples, the information is obtained automatically through workplace activity participation databases and employee communications.

In the present example, the process continues at 306 with obtaining employee personality profile data. As previously described, the employee personality profiles 116 can include information such as self-assessments, reviews by others, personality test results, self-provided biographies, and the like. This information can be manually and/or automatically collected depending on the implementation.

Next, in the present example, the process continues at 308 with obtaining employee inputs and/or assessments. This information can include any information that is desired but not gathered in the previous steps. In some examples, the previous steps may include more automated processes and this step would then include any manual inputs or assessments completed by the employee.

Although the present example includes gathering particular types of employee data, the employee data collected can vary depending on the desired implementation. For instance, the employee data may include a subset of the data described or additional types of data that may be helpful to determine employee interests in particular connection groups. The process and system can be tailored to the desires of a particular workplace or be available as an off-the-shelf version that can be customized in some applications.

According to various embodiments, once a connection group has been formed and employees have been assigned, it is beneficial to evaluate the success rates of the connection groups. In particular, these success rates can determine what types of groups should be continued, removed, or formed in the future. Additionally, the success rates can also determine whether employees should be moved into other groups, etc. These success rates can also be used to determine how engaged employees are with the connection groups and how satisfied the employees are with their interactions and relationships with fellow employees.

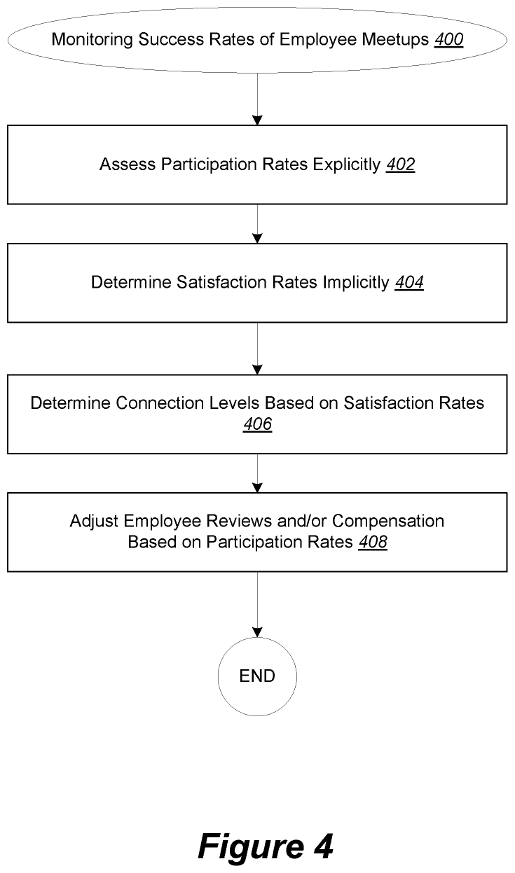

With reference to FIG. 4, shown is one example of a technique for monitoring success rates of employee meetups through explicit and implicit mechanisms. In the present example, monitoring success rates of employee meetups 400 begins at 402 with assessing participation rates explicitly. For instance, participation rates can be determined through such mechanisms as user input, time connected to a video conference, engagement with a game, and/or other connection group activity.

In the present example, satisfaction rates are then implicitly determined at 404. These satisfaction rates can be determined in a variety of ways, depending on the desired implementation. For instance, satisfaction rates can take into account aspects such as whether an employee returned to a connection group repeatedly, whether an employee left an event early, how much the employee participated during an activity, the total amount of time an employee has spent participating in a connection group, etc. If an employee returned to a connection group multiple times, then an inference can be made that the employee is enjoying the connection group and the satisfaction rate can be increased. If an employee left a connection group early, or didn't return for subsequent sessions with the connection group, then an inference can be made that the employee isn't a good match for the connection group and satisfaction level can be decreased. In some cases, the satisfaction level can reflect the employee's desire to engage in a particular connection group, but may also reflect scheduling conflicts as well if the employee does not return to a group because of conflicts in their schedule.

Next, in the present example, connection levels are determined at 406 based on satisfaction rates. Connection levels can be determined in a variety of ways depending on the desired implementation. For instance, connection levels can indicate how well a particular employee matches a particular connection group. Specifically, if the employee has high satisfaction levels with a particular group or activity, their connection level can reflect that. In some examples, connection levels can be designated overall, for particular connection groups, and/or between employees. For instance, an overall connection level can indicate an employee's overall participation and satisfaction with the system. Furthermore, connection levels with particular groups can indicate how much the employee has engaged with these groups and how satisfied they were with those experiences. Additionally, connection levels between employees may indicate how much certain employees interact with one another, and whether that interaction appears to be positive.

In the present example, the process 400 continues at 408 by adjusting employee reviews and/or compensation based on participation rates. For instance, employee reviews may include information about often they participate in connection group activities because such participation reflects how invested employees seem in their workplace. Also, in some workplaces, employee participation in the connection groups may be included in the employee's performance if the employer requires participation in such groups. In addition, in some implementations, employee reviews may include social evaluations that are based on reviews by peers or supervisors who have interacted with the employees in connection groups. Especially in remote work environments, participation in connection groups may be an important part of ascertaining how well an employee is fitting into the workplace and bonding with others, and may be reflected in employee reviews. In addition, depending on the desired implementation of the system, an employer may also choose to adjust compensation based on employee participation, such as by providing bonuses for employees that reach a certain level of participation or feedback from peers and/or supervisors.

Although particular steps have been described in the present example, other combinations of steps can also be used to monitor success rates of employee meetups. As such the examples provided are not meant to be restrictive. For instance, an additional step can be provided or exchanged for one or more of the previously described steps in which satisfaction rates are determined explicitly. Specifically, employees would provide feedback about which connection groups and/or activities they liked the most and would like to participate in in the future. Additionally, in some examples, employees could explicitly designate connection levels with particular connection groups, activities, and/or employees. This explicitly provided information may be useful in determining how to improve the employees' experiences in the future and also indicate for the purposes of satisfaction and/or reviews what experiences and which employees that the employee prefers. This can help facilitate placement of the employee in the future in connection groups and working groups.

According to various embodiments, once an employee is assigned to a connection group and decides to attend a connection group activity, it is beneficial if the connection group includes a facilitator to provide an organized and consistent experience for the employee. In particular, facilitators can provide a consistent experience for the employee so that they know what to expect when they participate in connection group activities. Also, by providing a consistent experience, facilitator may encourage the employee to participate more in the future.

With reference to FIG. 5, shown is one example of a technique for facilitating a connection group 500. According to various examples, providing a virtual facilitator provides an organized and consistent experience for employees participating in the connection groups. Specifically, the connection groups can be automatically facilitated to allow employees to easily engage with connection group activities without the need for a human moderator or leader. Furthermore, a facilitator encourages employee engagement with the connection groups by providing guidance for participants.

In the present example, process 500 begins with welcoming employees to the connection group activity at 502. For instance, when a new participant joins an activity, the facilitator can welcome the participant in a chat to both ease the participant into the activity and to introduce the participant to other employees already in attendance. In some examples, the facilitator may also help assign the participant to a team or subgroup if a game or activity has already begun.

Next, in the present example, the facilitator provides any appropriate instructions, rules, and/or goals to the employees regarding the connection group activity at 504. For instance, the facilitator can lead the chat by providing information about the group activity. In some instances, the facilitator may ask the participants to split into teams or groups. Depending on the activity, the facilitator may also assign participants to particular teams or roles. The facilitator can then help the participants begin the activity. In some ways, the facilitator acts as a tour guide that leads participants through the activity.

In the present example, the process continues at 506 by providing prompts as necessary to encourage participation by employees in the connection group activity. For instance, if the activity is a group chat, the facilitator may provide prompts to start the conversation or provide topics. If there is a lull in the conversation, the facilitator can provide prompts to encourage participants to engage. If the activity is a game, the facilitator may prompt users that have been eliminated, etc. to engage them more fully while they are waiting for a game to end.

Next, in the present example, the process 500 continues at 508 by providing closing remarks and/or leading a discussion before the connection group activity ends. For instance, the facilitator can lead a question/answer discussion before ending the activity in which participants can ask each other questions. Similarly, after a gaming activity has ended, the facilitator can lead a discussion about the results and encourage any congratulatory remarks or comments from the participants. According to various examples, the facilitator can make closing remarks, which may include thanks for attending, information about future events, requests for feedback, etc.

Although particular features have been described with regard to facilitating an activity, other interactive features can also be included, depending on the implementation. For instance, the facilitation may include help features or reporting features if desired. Specifically, the facilitator can provide a prompt offering to help if a participant enters a question or starts a chat with the facilitator. Similarly, reporting features can be made available through the facilitator if there are problems that participants encounter. In some implementations, the help and reporting features can be hidden or private so that a participant can discreetly request help with any questions or problems from the facilitator.

In the present example, the facilitator is automated to function without a specific person leading an activity. However, the facilitator can also incorporate human facilitators as well if desired. For instance, a chat feature can be included that allows a human facilitator to answer questions as necessary. Additionally, if a chat group is very discussion oriented and requires particular leadership and expertise, a human facilitator may also lead the discussion. In this case, the automatic facilitator can still provide basic greetings, introductions, information, etc. unless it is desirable to pause or mute the automatic facilitation.

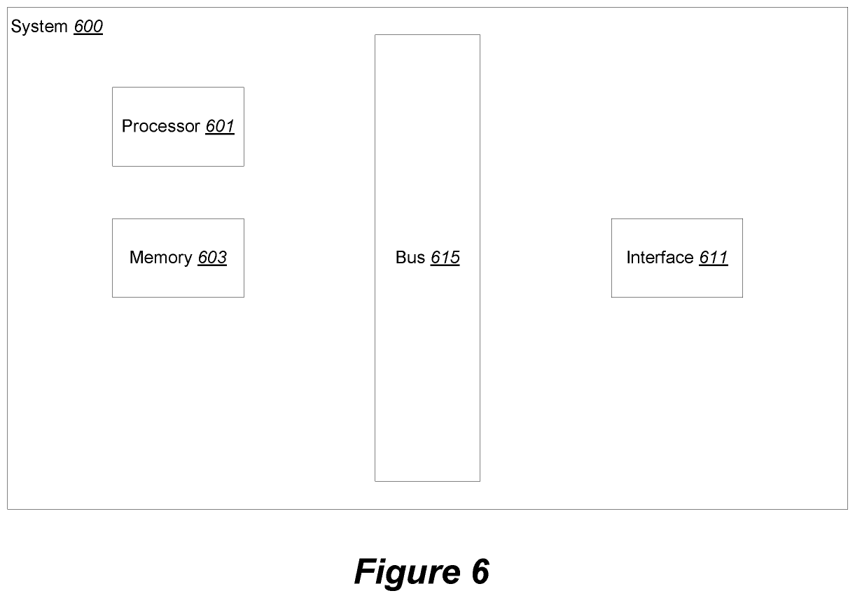

Various mechanisms and processes described in the present disclosure can be carried out with the help of a computer system. With reference to FIG. 6, shown is one example of a computer system that can be used to implement particular examples of the present invention. For instance, the computer system 600 can be used to implement a computing device, such as a mobile device, stationary device, computer, laptop, monitoring system, control system, etc., according to various embodiments described above. According to particular example embodiments, a system 600 suitable for implementing particular embodiments of the present invention includes a processor 601, a memory 603, an interface 611, and a bus 615 (e.g., a PCI bus). The interface 611 may include separate input and output interfaces, or may be a unified interface supporting both operations. When acting under the control of appropriate software or firmware, the processor 601 is responsible for such tasks such as optimization. Various specially configured devices can also be used in place of a processor 601 or in addition to processor 601. The complete implementation can also be done in custom hardware. The interface 611 is typically configured to send and receive data packets or data segments over a network. Particular examples of interfaces the device supports include Ethernet interfaces, frame relay interfaces, cable interfaces, DSL interfaces, token ring interfaces, and the like.

In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management.

According to particular example embodiments, the system 600 uses memory 603 to store data and program instructions and maintain a local side cache. The program instructions may control the operation of an operating system and/or one or more applications, for example. The memory or memories may also be configured to store received metadata and batch requested metadata.

Because such information and program instructions may be employed to implement the systems/methods described herein, the present invention relates to tangible, machine readable media that include program instructions, state information, etc. for performing various operations described herein. Examples of machine-readable media include hard disks, floppy disks, magnetic tape, optical media such as CD-ROM disks and DVDs; magneto-optical media such as optical disks, and hardware devices that are specially configured to store and perform program instructions, such as read-only memory devices (ROM) and programmable read-only memory devices (PROMs). Examples of program instructions include both machine code, such as produced by a compiler, and files containing higher level code that may be executed by the computer using an interpreter.

### CONCLUSION

While the present disclosure has been particularly shown and described with reference to specific embodiments thereof, it will be understood by those skilled in the art that changes in the form and details of the disclosed embodiments may be made without departing from the spirit or scope of the invention. Specifically, there are many alternative ways of implementing the processes, systems, and apparatuses described. It is therefore intended that the invention be interpreted to include all variations and equivalents that fall within the true spirit and scope of the present invention. Moreover, although particular features have been described as part of each example, any combination of these features or additions of other features are intended to be included within the scope of this disclosure. Accordingly, the embodiments described herein are to be considered as illustrative and not restrictive. Furthermore, although the foregoing concepts have been described in some detail for purposes of clarity of understanding, it will be apparent that certain changes and modifications may be practiced within the scope of the appended claims.

What is claimed is:

1. A method comprising:
determining interest information for a plurality of employees in a workplace environment, wherein interest information is determined by analyzing employee work product, employee communications, and personality profiles;
analyzing the interest information to place the plurality of employees into a plurality of connection groups including game groups and chat groups;
calendaring and scheduling the game groups and chat groups upon reviewing the work availability calendars of the plurality of employees; and
tracking participation rates to determine connection levels to enhance the plurality of connection groups, wherein participation rates are further tracked to automatically adjust employee reviews.

2. The method of claim 1, wherein the participation rates are explicitly assessed.

3. The method of claim 1, wherein satisfaction rates are further used to determine connection levels.

4. The method of claim 1, wherein satisfaction rates are implicitly determined based on implicit user interactions with the game groups and chat groups.

5. The method of claim 4, wherein implicit user interactions include time connected to a video conference and engagement with a game.

6. The method of claim 1, wherein chat groups are automatically scheduled on a plurality of employee calendars.

7. The method of claim 1, wherein game groups are automatically scheduled on a plurality of employee calendars.

8. The method of claim 1, wherein participation rates are used to adjust employee compensation.

9. The method of claim 1, further comprising facilitating the connection groups virtually to provide an organized and consistent experience for employees participating in the connection groups.

10. A system comprising:
an interest analysis system configured to determine employee interests for a plurality of employees using employee data;
a connection and calendaring system configured to match the plurality of employees with connection groups using employee interests, wherein the connection and calendaring system is further configured to add calendar events for the connection groups on employee calendars based on schedule availability of the plurality of employees;
a facilitation system configured to encourage employee engagement with the connection groups by providing guidance for participants; and
a tracking system configured to assess participation rates and satisfaction rates to improve placement of employees in connection groups, provide employee reviews, and adjust compensation as appropriate.

11. The system of claim 10, wherein the employee data is collected through manual data input and automatic data input;

12. The system of claim 10, wherein the employee data is obtained through manual input.

13. The system of claim 10, wherein the employee data is obtained through automatic input.

14. The system of claim 10, wherein the employee data includes employee work product data.

15. The system of claim 10, wherein the employee data includes employee personality profiles.

16. The system of claim 10, wherein the employee data includes employee communications data.

17. The system of claim 10, wherein the employee data includes employee calendar data.

18. The system of claim 10, wherein the facilitation system guidance includes providing prompts and information to participants of a connection group event.

19. The system of claim 10, wherein the connection and calendaring system is further configured to determine connection levels based on satisfaction rates.
